(19) United States
(12) Patent Application Publication
(10) Pub. No.: US 2026/0070568 A1
(43) Pub. Date: Mar. 12, 2026

(54) Method and Device for View-Based Control of a Vehicle Function

(71) Applicant: Bayerische Motoren Werke Aktiengesellschaft, Muenchen (DE)

(72) Inventors: Simone CAMBERG, Muenchen (DE); Celian Cherrier, Muenchen (DE); Thomas Ewender, Bad Aibling (DE); Johannes Feldmaier, Ebersberg (DE)

(21) Appl. No.: 19/325,064

(22) Filed: Sep. 10, 2025

(30) Foreign Application Priority Data
Sep. 11, 2024 (DE) 10 2024 126 143.9

(51) Int. Cl. B60W 50/00; B60W 40/08; B60W 50/14; B60W 60/00; G06V 20/59; G06V 40/18

(52) U.S. Cl. CPC B60W 50/0098; B60W 40/08; B60W 50/14; B60W 60/0018; G06V 20/597; G06V 40/18; B60W 2040/0818; B60W 2050/0083; B60W 2050/146; B60W 2420/403; B60W 2540/225; B60W 2540/229; B60W 2554/406

(57) ABSTRACT

A device for controlling a vehicle function of a vehicle includes a processor configured to determine that the user of the vehicle has a viewing direction deviation of: (a) viewing direction vectors of the left eye and (b) viewing direction vectors of the right eye of the user. The processor is configured to, in response to the determination, effectuate at least one measure with respect to a view-based control of a vehicle function of the vehicle.

### CROSS REFERENCE TO RELATED APPLICATION

This application claims priority under 35 U.S. C. § 119 from German Patent Application No. 10 2024 126 143.9, filed Sep. 11, 2024, the entire disclosure of which is herein expressly incorporated by reference.

### BACKGROUND AND SUMMARY

The invention relates to a method and a corresponding device, which are directed to enabling a view-based control of one or more vehicle functions.

A vehicle can have one or more vehicle functions which can be controlled on the basis of the view of a user, in particular the driver, of the vehicle. For example, it can be made possible for the driver of the vehicle to cause an automated lane change of the vehicle by way of a view into the rearview mirror.

The present document relates to the technical problem of effectuating a particularly reliable and robust view-based control of one or more vehicle functions.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to an aspect, a device for controlling a vehicle function of a (motor) vehicle is described. The vehicle function can be designed to longitudinally and/or laterally guide the vehicle in an automated manner. Alternatively, the vehicle function can be a comfort function or an infotainment function of the vehicle.

The device is configured to determine that a user (in particular the driver) of the vehicle has a viewing direction deviation from viewing direction vectors of the left and viewing direction vectors of the right eye of the user. A viewing direction deviation of the two eyes can exist, for example, if the viewing direction vectors of the two eyes (on average) deviate from one another by more than a specific deviation threshold value (for example, by more than a specific angle). A viewing direction deviation of the two eyes can correspond to a strabismus of the two eyes.

The device can be configured to capture camera data with respect to the user by means of an (interior) camera of the vehicle. It can then be determined in a reliable manner on the basis of the camera data that the user has a viewing direction deviation.

The device can be configured in particular to measure a viewing direction vector of the left eye and a viewing direction vector of the right eye at a specific measuring time on the basis of the camera data. It can then be determined on the basis of the measured viewing direction vector of the left eye and on the basis of the measured viewing direction vector of the right eye at the specific measuring time, in particular on the basis of a deviation measured for the deviation of the measured viewing direction vectors from one another, that the user has a viewing direction deviation.

Viewing direction vectors can possibly be ascertained for each of a plurality of measuring times and compared with one another in order to determine (by way of an average observation of the deviations of the measured viewing direction vectors of the two eyes) whether the user has a viewing direction deviation or not.

The device can be configured to prompt the user via the user interface of the vehicle to observe a specific measurement object at the specific measuring time. The user can possibly be prompted to observe different measurement objects in each case at different measuring times (for example, measurement objects arranged at different distances). The viewing direction vectors of the two eyes can then each be measured and compared with one another. It can thus be recognized in a particularly robust and reliable manner whether the user has a viewing direction deviation or not.

Alternatively, or additionally, the device can be configured to determine on the basis of a user profile stored beforehand and/or on the basis of a user input via the user interface of the vehicle that the user has a viewing direction deviation.

The device may be configured, in reaction to the determination that the user has a viewing direction deviation, to effectuate at least one measure with respect to a view-based control of the vehicle function of the vehicle (by the user).

The device can be configured to effectuate as a measure that the view-based control of the vehicle function (by the user) is suppressed (if it is determined that the user has a viewing direction deviation).

Alternatively, or additionally, as a measure the operating mode of the viewing-based control of the vehicle function can be adapted (to the viewing direction deviation of the user).

The device can be configured, for example, to determine one or more parameters with respect to the viewing direction deviation of the user (e.g., on the basis of the camera data, on the basis of the user profile, and/or on the basis of the user input). Exemplary parameters are a specification as to which of the two eyes of the user is to be used to determine the viewing direction of the user, and/or a correction value which is to be applied to a measured viewing direction vector of an eye of the user in order to determine the viewing direction of the user.

The view-based control of the vehicle function of the vehicle can then be operated in a particularly reliable manner depending on the one or more parameters. In particular, the viewing direction of the user which is used for the control of the vehicle function can be determined depending on the one or more parameters.

The device can be configured, for example, to effectuate as a measure that in the scope of the view-based control of the vehicle function, either only the left eye or only the right eye of the user is used for the determination of the viewing direction of the user.

A particularly reliable and robust view-based control of one or more vehicle functions by the user can be effectuated by the recognition and consideration of a viewing direction deviation of the eyes of a user.

The device can be configured, in the scope of the view-based control of the vehicle function, to determine the (respective current) viewing direction of the user on the basis of camera data of the (interior) camera of the vehicle. The method used to determine the viewing direction of the user can depend here on whether the user has a viewing direction deviation or not. The vehicle function can then be controlled in a comfortable manner depending on the determined viewing direction. For example, it can be determined depending on the determined viewing direction whether the user has made a user input with respect to the vehicle function or not. Furthermore, a control command of the user to control the vehicle function can be determined on the basis of the determined viewing direction.

The device can be configured to determine on the basis of the determined viewing direction whether the user has a sufficiently high degree of attentiveness with respect to the traffic situation in which the vehicle is located. The vehicle function can be degraded, in particular with respect to the automated longitudinal and/or lateral guidance of the vehicle, if it is determined that the user does not have a sufficiently high degree of attentiveness. Particularly safe automated longitudinal and/or lateral guidance of the vehicle can thus be effectuated.

At least one embodiment may comprise a (road) motor vehicle (in particular a passenger car or a truck or a bus or a motorcycle), which comprises the device described in this document.

A method for controlling a vehicle function of a (motor) vehicle is described is described in accordance with at least one embodiment. The method comprises determining that a user, in particular the driver, of the vehicle has a viewing direction deviation of viewing direction vectors of the left eye and viewing direction vectors of the right eye. The method furthermore comprises, in reaction to the determination, causing at least one measure with respect to a viewing-based control of a vehicle function (in particular a vehicle function for automated longitudinal and/or lateral guidance) of the vehicle (by the user).

It is to be noted that the aspects described in conjunction with the device, in particular the claims described in conjunction with the device, are also to be applied to the method as corresponding method features.

A software (SW) program is described in accordance with at least one embodiment. The SW program can be configured to be executed on a processor (for example, on a control unit of a vehicle), and to thus carry out the method described herein.

A storage medium is described in accordance with at least one embodiment. The storage medium can comprise an SW program, which is configured to be executed on a processor and carry out the method described herein.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention will be described in more detail hereinafter on the basis of exemplary embodiments. In the figures

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2 shows exemplary measured viewing direction vectors of the right and the left eye of a user, in particular the driver, of a vehicle; and

FIG. 3 shows a flow chart of an exemplary method for controlling a vehicle function on the basis of the view, in particular on the basis of the viewing direction, of a user of a vehicle.

### DETAILED DESCRIPTION OF THE DRAWINGS

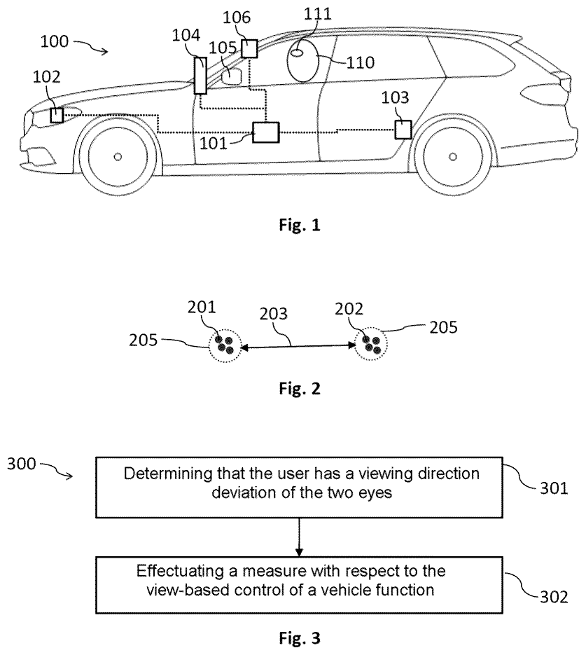

As described at the outset, the present document relates to providing a reliable and robust viewing-based control of a vehicle function of a vehicle. In this context, FIG. 1 shows an exemplary vehicle 100 having one or more surroundings sensors 102, which are each configured to capture sensor data (which are also referred to as surroundings data) with respect to the surroundings of the vehicle 100. Exemplary surroundings sensors 102 are a camera, a radar sensor, a lidar sensor, an ultrasonic sensor, etc.

A (control) device 101 of the vehicle 100 can be configured to evaluate the surroundings data, for example, to recognize one or more objects (such as other vehicles) in the surroundings of the vehicle 100. The device 101 can furthermore be configured to effectuate an automated longitudinal and/or lateral guidance of the vehicle 100 on the basis of the surroundings data, in particular on the basis of the one or more detected objects. For this purpose, one or more longitudinal and/or lateral guidance actuators 103 (e.g., a drive motor, a braking device, and/or a steering device) of the vehicle can be actuated.

The control device 101 can be configured, for example, to recognize on the basis of the surroundings data that during a journey of the vehicle 100 on a multilane roadway, a change from the current lane to an adjacent lane is possible (for example, to carry out an overtaking procedure). In reaction thereto, a notification on the possible lane change can be caused to be output via a user interface 104 of the vehicle 100.

The driver 110 of the vehicle 100 thereupon has the possibility of looking into the rearview mirror 105 of the vehicle 100 in order to thus cause a user input to the effect that the possible lane change is to be carried out. The vehicle 100 can have an (interior) camera 106 directed toward the driver 110, which is designed to capture camera data with respect to the driver 110, in particular with respect to the viewing direction of the driver 110. The (control) device 101 can be configured to recognize on the basis of the camera data that the driver 110 looks into the rearview mirror 105. Based thereon, it can be determined that the lane change is to be carried out. Furthermore, the one or more longitudinal and/or lateral guidance actuators 103 of the vehicle 100 can be actuated to carry out the lane change to the adjacent lane (using automated longitudinal and/or lateral guidance.

It can therefore be made possible for the driver 110, in general a user, of the vehicle 100 to make one or more user inputs to control a vehicle function on the basis of the view. The camera data which are captured by the camera 106 directed onto the driver 110 can be evaluated to ascertain the alignment (of the pupils) of the right and/or left eye 111, and to ascertain the viewing direction of the driver 110 based thereon. The local area (for example, the rearview mirror 105), which is observed by the driver 110, can be recognized on the basis of the viewing direction (possibly in combination with the position of the head of the driver 110). Based on the observed local area, it can be determined whether a view-based user input was made by the driver 110 or not.

Therefore, the position of the pupil and/or the iris of an eye 111 of the driver 110 can be ascertained on the basis of the camera data in order to ascertain the viewing direction vector of this eye 110 based thereon. A viewing direction vector can be ascertained for each of the two eyes 111 in a corresponding manner. The effective viewing direction of the driver 110 can be ascertained based on the viewing direction vectors of the two eyes 111.

A plurality of measured viewing direction vectors 201 of the left eye 111 and a plurality of measured viewing direction vectors 202 of the right eye 111 are shown by way of example in FIG. 2. An effective and/or averaged viewing direction vector 205 for the respective eye 111 can be ascertained in each case from the plurality of measured viewing direction vectors 201, 202.

In a person having relatively severe strabismus, the viewing direction vectors 201, 202, 205 of both eyes 111 extend in different directions so that a statement with respect to the viewing direction of the person is not possible, by which a view-based control of a vehicle function is impaired.

The (control) device 101 of the vehicle 100 can be configured to ascertain the viewing direction vectors 201, 202, 205 for the right and for the left eye 111 of the driver 110 on the basis of the camera data of the (interior) camera 106. Furthermore, a degree of the deviation of the viewing direction vectors 201, 202, 205 of the right and the left eye 111 can be ascertained. The degree of deviation can depend, for example, on the deviation 203, in particular on the distance, of the measured viewing direction vectors 201, 202, 205 of the right and the left eye 111.

A plurality of measured values with respect to the deviation 203 of the viewing direction vectors 201, 202 for the right and for the left eye 111 can be ascertained over a specific measuring period of time. The effective degree of deviation of the viewing direction vectors 201, 202 can then be ascertained based on the plurality of measured values. In particular, it can be determined whether the driver 110 has strabismus (and therefore a relatively large degree of deviation of the viewing direction vectors 201, 202 is present) or not (at therefore a relatively small degree of deviation of the viewing direction vectors 201, 202 is present). The strabismus of the driver 100 can be referred to as the viewing direction deviation of the two eyes 111 of the driver 100.

The driver 110 can possibly be prompted in the measuring period of time to observe a specific test object in order to measure the viewing direction vectors 201, 202 of the two eyes 111 in a particularly reliable and precise manner. Multiple different test objects can possibly be specified here, which are possibly arranged at different distances from the driver 110. The viewing direction vectors 201, 202 can thus be ascertained for different distance ranges (for example, close range or long range).

Exemplary viewing direction vectors 201, 202 can each be represented by a line, e.g.
(\)—viewing direction vector to the left;
(|)—viewing direction vector straight ahead; or
(/)—viewing direction vector to the right.

The following combinations (for the left or for the right eye 111) can possibly be recognized for both eyes 111:
(|) (|),
(/) (|),
(|) (\),
(|) (/),
(\) (|), or
(/) (\).

The first combination can indicate that no strabismus (i.e. no viewing direction deviation) is present, while the other combinations each indicate a strabismus (i.e. a viewing direction deviation of the eyes 111) of the driver 110.

When it is recognized that the driver 110 has strabismus, a notification in this regard can be output via the user interface 104 of the vehicle 100 (in order to inform the driver 110 about the recognized strabismus).

Alternatively, or additionally, a vision test (for example, having a defined area of interest) can be offered and/or carried out in the vehicle 100. A calibration of the view recognition can be carried out by the vision test, in order to increase the reliability of the view-based control of a vehicle function. In particular, one or more parameters can be ascertained for the ascertainment of the viewing direction of the driver 110 in the view-based control of a vehicle function.

The driver 110 can possibly be enabled to proactively specify via the user interface 104 that a divergence of the viewing direction vectors 201, 202, 205 (i.e. a viewing direction deviation) of both eyes 111 exists. One or more properties of the viewing direction deviation can possibly also be specified. In particular, the eye 111 (for example, right or left eye) which is to be used for the ascertainment of the viewing direction can possibly be specified.

The device 101 can therefore be configured to ascertain the eye 111 of the two eyes 111 of the driver 110 which is to be used for the view-based control of the one or more vehicle functions. This information can possibly be stored in a user profile of the driver 110 in a storage unit of the vehicle 100. The other eye 111 (affected by strabismus) can then remain unconsidered in the ascertainment of the viewing direction (for the view-based control of a vehicle function). A reliable view-based control of a vehicle function can thus be effectuated even with a driver 110 having divergent viewing direction vectors 201, 202, 205.

FIG. 3 shows a flow chart of a (possibly computer-implemented) method 300 for controlling a vehicle function of a (motor) vehicle 100. The method 300 can be carried out by a control device 101 of the vehicle 100. The vehicle function can be designed, for example, to longitudinally and/or laterally guide the vehicle 100 in an automated manner.

The method 300 comprises determining 301 that a user 110, in particular the driver, of the vehicle 100 has a viewing direction deviation of viewing direction vectors 201 of the left eye 111 and viewing direction vectors 202 of the right eye 111 of the user 110. A viewing direction deviation can exist, for example, if the viewing direction vectors 201, 202 of the right and the left eye 110 (when observing the same object) deviate from one another by more than a predefined threshold value (for example, by more than a specific angle). It can be recognized on the basis of camera data of a vehicle camera 104, on the basis of a user profile, and/or on the basis of a user input that the user 110 has a viewing direction deviation.

The method 300 furthermore comprises, in reaction to the determination 301, effectuating 302 at least one measure with respect to a view-based control of a vehicle function of the vehicle 100 (by the user 110). In the scope of the view-based control of the vehicle function, the viewing direction of the user 110 can be ascertained (possibly repeatedly). It can be effectuated as a measure that the viewing direction of the user 110 is ascertained depending on whether the user 110 has a viewing direction deviation (of the right and the left eye 111) or not.

A particularly reliable and robust view-based control of one or more vehicle functions can be effectuated by the measures described in this document.

The present invention is not restricted to the exemplary embodiment shown. In particular, it is to be noted that the description and the figures are only to illustrate the principle of the proposed methods, devices, and systems by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for controlling a vehicle function of a vehicle, comprises:
a processor configured to:
determine that a user of the vehicle has a viewing direction deviation of: (a) viewing direction vectors of the left eye and (b) viewing direction vectors of the right eye of the user; and
in reaction to the determination, effectuate at least one measure with respect to a view-based control of a vehicle function of the vehicle.

2. The device of claim 1, wherein the processor is configured to:
capture camera data with respect to the user by means of a camera of the vehicle; and
determine on the basis of the camera data that the user has the viewing direction deviation.

3. The device of claim 2, wherein the processor is configured to:
on the basis of the camera data, measure a viewing direction vector of the left eye and a viewing direction vector of the right eye at a specific measuring time; and
on the basis of a deviation measure for a deviation of the measured viewing direction vector of the left eye and the measured viewing direction vector of the right eye from one another at the specific measuring time, determine that the user has a viewing direction deviation.

4. The device of claim 3, wherein the processor is configured to prompt the user via a user interface of the vehicle to observe a specific measurement object at the specific measuring time.

5. The device of claim 1, wherein the processor is configured to:
determine, on the basis of a user profile of the user stored beforehand and/or on the basis of a user input via a user interface of the vehicle, that the user has a viewing direction deviation.

6. The device of claim 1, wherein the processor is configured to:
ascertain one or more parameters with respect to the viewing direction deviation of the user; and
operate the view-based control of the vehicle function of the vehicle depending on the one or more parameters.

7. The device of claim 6, wherein the one or more parameters comprise:
a specification as to which of the two eyes of the user is to be used to ascertain the viewing direction of the user; and/or
a correction value which is to be applied to a captured viewing direction vector of an eye to ascertain the viewing direction of the user.

8. The device of claim 1, wherein the processor is configured to:
effectuate as a measure, that in the scope of the view-based control of the vehicle function, either only the left eye or only the right eye of the user is used for the ascertainment of the viewing direction of the user.

9. The device of claim 1, wherein the processor is configured to:
effectuate as a measure, that the view-based control of the vehicle function is suppressed.

10. The device of claim 1, wherein the processor is configured, in the scope of the view-based control of the vehicle function, to:
ascertain a viewing direction of the user on the basis of camera data of a camera of the vehicle, wherein a method for ascertaining the viewing direction of the user is dependent on whether the user has a viewing direction deviation or not; and
to control the vehicle function depending on the ascertained viewing direction.

11. The device of claim 10, wherein the processor is configured to:
determine on the basis of the ascertained viewing direction whether the user has a sufficiently high degree of attentiveness with respect to a traffic situation in which the vehicle is located; and
degrade the vehicle function with respect to an automated longitudinal and/or lateral guidance of the vehicle if it is determined that the user does not have a sufficiently high degree of attentiveness.

12. A method for controlling a vehicle function of a vehicle, comprising:
determining that a user of the vehicle has a viewing direction deviation of: (a) viewing direction vectors of the left eye and (b) viewing direction vectors of the right eye of the user; and
in reaction to the determination, effectuating at least one measure with respect to a view-based control of a vehicle function of the vehicle.
